(19) United States
(12) Patent Application Publication
(10) Pub. No.: US 2012/0147192 A1
(43) Pub. Date: Jun. 14, 2012

(54) VIDEO CAMERA SYSTEM

(75) Inventors: Dennis George Herbert Wright, Chester Hill (AU); David John Maher, Chester Hill (AU)

(73) Assignee: DEMAHER INDUSTRIAL CAMERAS PTY LIMITED, Chester Hill (AU)

(21) Appl. No.: 13/392,516

(22) PCT Filed: Sep. 1, 2010
(86) PCT No.: PCT/AU2010/001122

§ 371 Date: Feb. 24, 2012

(30) Foreign Application Priority Data
Sep. 1, 2009 (AU) 2009904188

(51) Int. Cl. H04N 7/18

(52) U.S. Cl. 348/159; 348/E07.085

(57) ABSTRACT

A video camera and computer system for detecting events comprising: a processor in communication with a plurality of sensors and a camera over a communications network. The processor receives multiple data streams from the sensors, analyses the received data streams to detect an event and sends a trigger to the camera to capture video footage when an event is detected. Upon an event or alert, the processor: generates an event description associated with the detected event based on the data streams or the alert from the camera, links the generated description with an identifier of the captured video footage associated with the event, and stores the linked description and identifier to facilitate searching and retrieval of the captured video footage associated with the detected event.

### TECHNICAL FIELD

This invention concerns video camera systems in general, and more particularly to a computer system for detecting events, a method for detecting events, and computer program to implement the system.

### BACKGROUND ART

Video camera systems have become increasingly ubiquitous in both outdoor and indoor areas, and are useful as referral back to events such as criminal incidents. For example, it is estimated that there are 80 cameras located across Central Sydney alone, the cameras operating 24 hours per day, seven days a week. With the capture of vast amount of video footage comes a new challenge to better manage storage of the footage storage for later retrieval. One key problem is that video footage is one of the most time-consuming forms of information to search through. Even if adequate human resources are dedicated to this task, the entire footage needs to be reviewed, potentially exposing private video footage irrelevant to an event of interest.

DISCLOSURE OF THE INVENTION

In a first aspect, there is provided a computer system for detecting events, the system comprising:
a processor, a plurality of sensors and a camera, the processor in communication with the sensors and the camera over a communications network;
the processor is operable to receive multiple data streams from the sensors, to analyse the received data streams to detect an event, to send a trigger to the camera to capture video footage when an event is detected by the processor;
the camera is operable to capture video footage when a trigger is received from the processor, and to capture video footage and send an alert to the processor when an event is detected by the camera, and
when an event is detected by the processor or an alert is received from the camera, the processor is operable to:
   generate an event description associated with the detected event based on the data streams or the alert from the camera,
   link the generated description with an identifier of the captured video footage associated with the event, and store the linked description and identifier to facilitate searching and retrieval of the captured video footage associated with the detected event.

Advantageously, the processor increases the capability of the camera by providing a means to detect events based on data streams collected by a plurality of sensors that are neither integrated with, nor directly connected to, the camera. As such, it is not necessary for the camera to be modified to incorporate additional input ports to accommodate the sensors because direct physical connections are not required.

Detected events, and their description, are stored to facilitate searching and retrieval of video footage based on the description. This enables a user to centralise search operations and review video footage that is only relevant to the search operations. Advantageously, it is not necessary to scan video footage sequentially to resolve security issues and therefore the risk of a user viewing of potentially private video footage that is not relevant to a particular search operation is reduced, if not eliminated.

The processor may be further operable to send the linked event description and identifier to the camera for recordal with the captured video footage associated with the detected event.

In this case, the camera is further operable to:
receive the linked event description and identifier from the processor; and
record the received linked event description and identifier with the video footage in an encoded and encrypted format, which may be MxPeg.

The processor may be further operable to calculate a checksum associated with the detected event and to send the calculated checksum to the camera for recordal with the captured video footage associated with the detected event.

The checksum may be calculated based on the data streams and the identifier of the captured video footage associated with the detected event.

The processor may be further operable to send user-defined text to the camera for recordal with the captured video footage associated'with the detected event. The linked description and identifier may be stored in a searchable index.

The processor may be further operable to send a control signal to a device to perform a task based on the detected event.

The processor may be further operable to receive time references from the camera and from the sensors, and to trigger a time synchronisation event if the received time references are not synchronised

An event may be detected by the processor based on at least one of the data streams satisfying a trigger rule associated with an event. In this case, searching and retrieval of the video footage may be based on the one or more trigger rules.

Searching and retrieval of the video footage may be based on one or more of the following search parameters:
date and time;
event description;
trigger rules of an event; and
identifier of video footage.

Further, retrieval of the captured video footage may only be permissible if a user is authorised to access the video footage.

The processor may be operable to receive data streams from the sensors by means of one of the following: digital communication, serial communication, analogue voltage reference, fieldbus communication and TCP/IP.

The processor may be further operable to collate the data streams received from the sensors into a unified format.

In a second aspect, the invention is computer program to implement the computer system.

In a third aspect, there is provided a computer-implemented method for detecting events, the method comprising:
receiving multiple data streams from a plurality of sensors and analysing the received data streams to detect an event, and triggering the camera to capture video footage associated with the detected event;
when an event is detected by the processor or an alert is received from the camera,
   generating an event description of the detected event based on the data streams or the alert;
   linking the generated event description and an identifier of the captured video footage, and storing the linked event description and identifier to facilitate searching and retrieval of the captured video footage associated with the detected event.

### BRIEF DESCRIPTION OF DRAWINGS

By way of a non-limiting example, the invention will now be described with reference to the accompanying drawings, in which:

FIG. 1 is a schematic diagram of a computer system for detecting events.

FIG. 2 is a flowchart of a method for detecting events.

FIG. 3 is a continuation of the flowchart in FIG. 2.

FIG. 4(a) is a screenshot of a user interface in an exemplary application with four cameras.

FIG. 4(b) is a screenshot of a user interface to change configurations of the cameras.

FIG. 5(a) is a screenshot of a Gate Keeper application.

FIG. 5(b) is a screenshot of a Harbour Master application.

FIG. 6 is a block diagram of a device layer of an exemplary application.

FIG. 7 is a block diagram of a programmable layer associated with the device layer in FIG. 6.

FIG. 8 is a block diagram of an application layer associated with the device later in FIG. 6 and the programmable layer in FIG. 7.

### DETAILED DESCRIPTION OF THE INVENTION

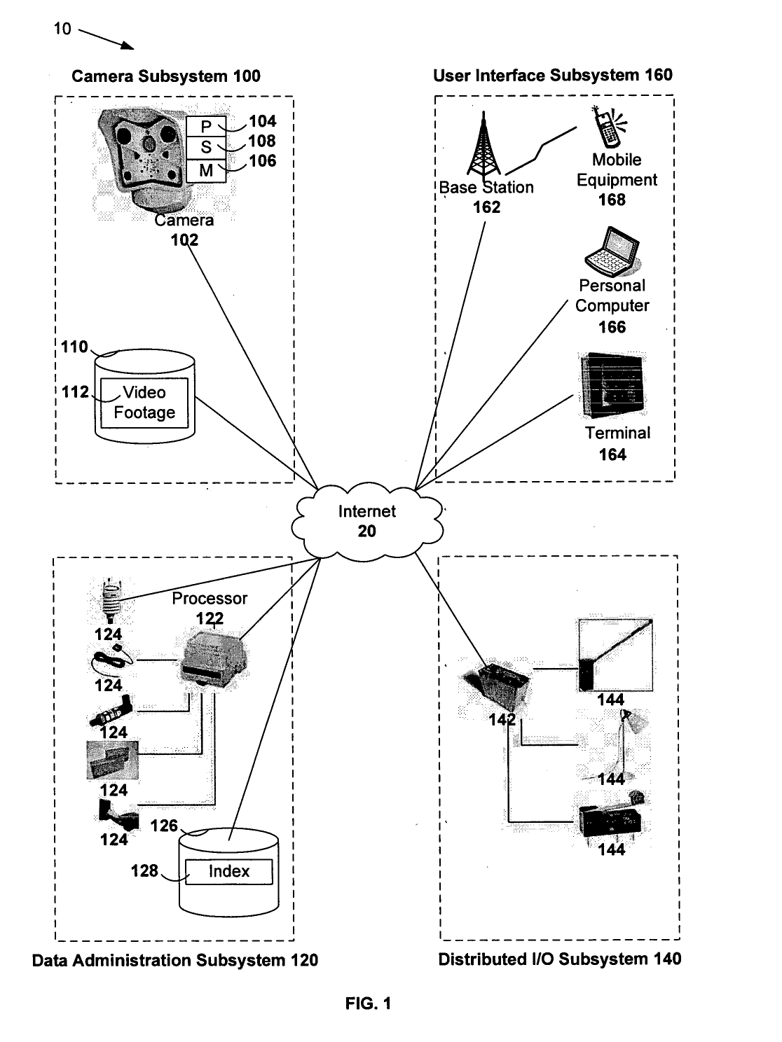

Referring first to FIG. 1, the computer system 10 for detecting events comprises the following subsystems:
Camera subsystem 100 to capture and store video footage.
Data administration subsystem 120 to detect events based on data streams collected by a plurality of sensors 124, to generate event descriptions when an event is detected and to store the event descriptions in a searchable index.
Distributed input/output subsystem 140 to respond to detected events. And,
User interface subsystem 160 to allow searching and retrieval of captured video footage.

The subsystems are in communication with each other via a data communications network such as the Internet 20, and collectively form an autonomous video capture, monitoring, storage and search system. Each subsystem will now be described in further detail.

Camera Subsystem 100

As shown in FIG. 1, camera subsystem 100 comprises at least one IP camera 102 to capture video footage. It will be readily appreciated that the term “video footage” 10 represents one or more video frames captured by the camera, or constructed from adjacent frames.

The camera 102 is capable of providing a two-way communication capability using Voice Over IP (VOIP), storing information from other sources such as sensors and devices, as well as recording images, and responding to pre-programmed events by recording images and motion at higher frame rates and setting alarms. The camera 102 can be installed indoor, outdoor or on-board a vehicle for a wide range of applications such as security, surveillance, logistics and transportation.

20 Video footage is captured by the camera 102 at a user-defined frame rate for a user-defined period of time when triggered by an external signal received from the data administration subsystem 120. As will be explained below, the data administration subsystem 120 detects an event by analysing multiple data streams collected by a plurality of sensors 124 having no direct physical connection with the camera 102.

Video footage is also captured by the camera 102 at a user-defined frame rate for a user-defined period of time when an event is detected by the camera 102 using one or more integrated or local sensors 108, such as when motion is detected. In this case, an identifier is allocated to each event and the captured video footage, and can be 30 transmitted with time and date information to the data administration subsystem 120 for subsequent processing.

Video footage, and additional information, is recorded in an encoded and encrypted format that prevents manipulation. For example, Linux-based Mobotix security cameras are suitable for this purpose, where video footage is recorded in MxPeg format.

An on-board processor 104 performs image processing on the video footage locally, which is stored temporarily in camera memory 106 before being exported to a more permanent storage system 110. The on-board processor 104 also supports viewing of stored video footage by a user via the Internet. Only authenticated users are allowed access to the video footage.

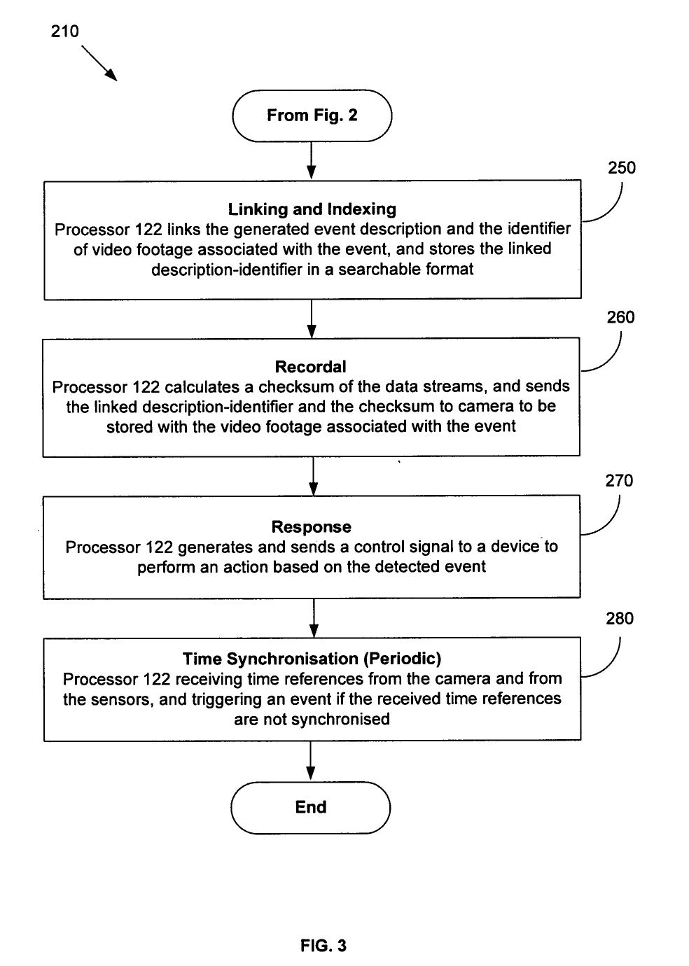

An internal clock (not shown) of the camera 102 provides the system 10 with a master time stamp. Time references from all devices in the system 10 can be synchronised with a Network Time Protocol source; see FIG. 3.

Data Administration Subsystem 120

Data administration subsystem 120 extends the functionality of the camera subsystem 100 by providing a means to record information from a number of external sensors 124 that are neither integrated with nor physically connected to the camera 102.

Processor 122 performs processing and routing of data streams from the sensors 124 to the camera subsystem 100 and user interface subsystem 160. Additional third party software can also be integrated with the processor 122 to enable functionality such as Optical Character Recognition (OCR) and audio-to-text conversion to process the data streams.

Sensors 124

The sensors 124 each interface with the processor 122 by means of one of the following:
Digital signal inputs and outputs ranging from 3.3 VDC to 24 VDC;
Analogue voltage references either 0-10V or 4-20 mA;
Serial communication including RS422, RS485 and RS232;
TCP/IP, such as via a local area network (LAN) and wireless LAN, either via an Access Point or on a peer to peer basis; and
Fieldbus communication, such as using Controller Area Network (CAN) protocol.

A range of sensors can be used, such as:
Distributed sensors that are deployed on the network, and generally powered via

Power over Ethernet (POE) and transmit data streams via notifications over TCP/IP.
Associated sensors that are situated locally and connected to the processor 122 via a hardwired arrangement, and generally transmit data streams by means of serial communication or a fieldbus protocol.
Integrated sensors that are embedded in distributed devices and generally transmit data streams by means of serial communication or a fieldbus protocol.

For example, digital inputs can be received when an arm of a rubbish bin truck is extended, a door is opened or closed, brake on a vehicle is applied, power is available and flow switch activation or deactivation. It will be readily appreciated that it is not necessary for the sensors 124 to be in the area captured in the associated video footage.

For example, data streams can be collected from:
temperature sensors;
remote weather monitoring station (serial communication);
load or weight system;
point of sale (POS) registers in a retail store;
card reader;
industrial process logic controllers (PLCs);
global positioning system (GPS); and
orientation sensors.

Data Collection 210

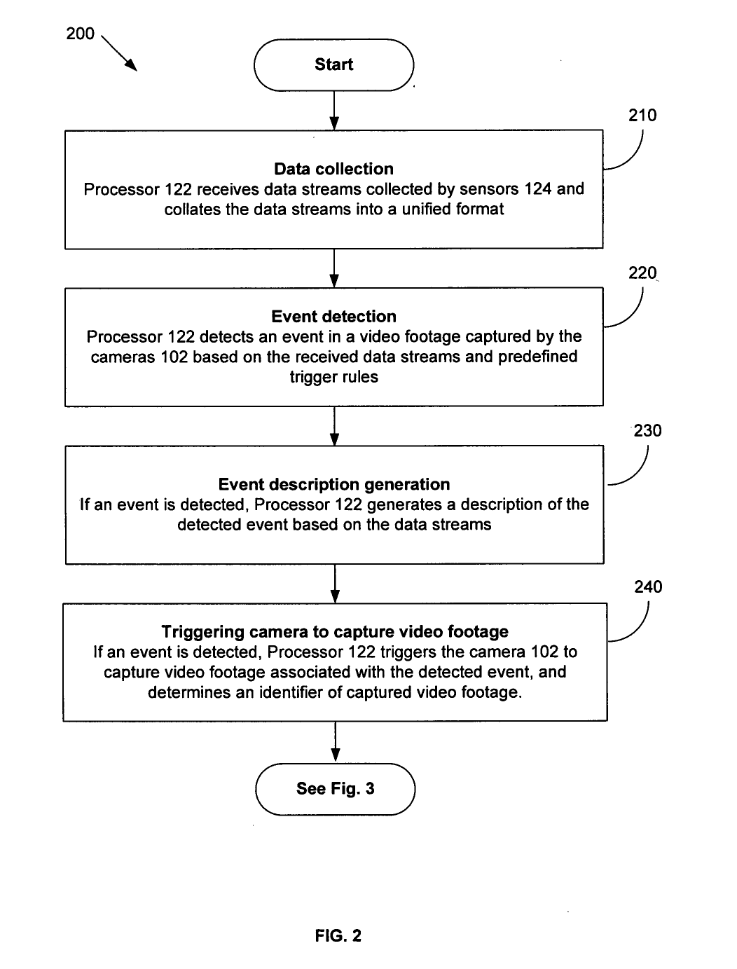

Referring now to FIG. 2, the processor 122 first receives multiple data streams from the sensors 124 and collates the data streams into a unified plain text format; see step 210. An on-board memory (not shown) provides a buffer to ensure no data overflow during the receipt and processing of the data streams

Event Detection 220

The collated data streams are then analysed to detect whether an event has occurred; see step 220. This involves the processor 122 analysing whether some predefined trigger rules associated with an event have been satisfied. Data streams from a combination of sensors 124 can be used. The values of the data streams can be interpreted directly, or using mathematical operations such as averaging, trend analysis, function estimation and probability calculation

For example, if the camera 102 is set up to monitor a bus, an event can be triggered when the speed of the bus exceeds the speed limit in a particular area within a predetermined period of time during the day. In this case, data streams from a speedometer, a GPS receiver and clock on the bus will be analysed. Again, these sensors 124 do not require any direct physical connection with the camera 102.

In another example, an event can be triggered when an arm of a rubbish bin truck is extended and when temperature in an area exceeds a particular threshold. In this case, digital inputs from the rubbish bin truck, and data streams from a temperature sensor and a GPS receiver will be analysed. In yet another example, an event can be triggered when a transaction of more than $50 is performed by a store member within a particular retail store. In this case, data streams from a POS register, a store member card reader, and a GPS received will be analysed.

Event Description Generation 230

A description of the detected event is then generated based on the data streams associated with the event; see step 240 in FIG. 2. The purpose is to index video footage associated with the detected event with searchable descriptions so as to facilitate searching and retrieval of video footage.

In the moving bus example above, event descriptions are such as “bus moving at 40 20 km/h on George Street”, “bus stopped at intersection between Market Street and George Street” and “bus exceeded speed limit on George Street”. Similarly, in the POS register example above, a suitable event description is “$120 sale transaction by member 1234”.

Triggering Camera to Capture Video Footage 240

If an event is detected, the processor 122 sends a trigger to the camera 102 to capture video footage associated with the detected event; see step 230 in FIG. 2. In particular, the processor 122 sends a series of IP packets to the camera 102 that sets it to capture video footage at a user-defined frame rate for a user defined period of time.

In this case, the processor 122 records data streams collected by the sensors 124 and adds them to a database record associated with the detected event. The processor 122 calculates an identifier of video footage associated with the detected event based on the trigger information (data in the IP packets) which is also added into the database.

Linking and Indexing 250

Referring now to FIG. 3, the processor 122 then links the generated event description the identifier associated with the video footage captured by the camera 102, and stores the linked description-identifier pair in a searchable index 128; see step 260. The purpose is to facilitate searching and retrieval of the video footage using the user interface subsystem 160.

Advantageously, a combination of search parameters can be used to search the video footage, taking advantage of the inherence correlation of data streams collected by the sensors 124. For example, a combination of time, date, event identifier, trigger rules and event description can be used.

A user is only authorised to access video footage that is related to the search parameters entered, or specific categories of events. Advantageously, potential privacy issue is alleviated because only video footage associated with a search parameter or right of access can be accessed. It is also not necessary to scan the entire video footage to resolve security issues, protecting the privacy of those not involved in the event.

The index 128 is generally a comma separated values (CSV) file. For example, if the system is set up to monitor a bus, the following file is generated and to facilitate searching and video footage retrieval.

| | | Camera | Camera | Footage | Event |
|---|---|---|---|---|---|
| Date | Time | date | time | ID | description |
| Dec. 6, 2009 | 12:00:09 | Dec. 6, 2009 | 12:00:09 | 2345 | Bus moving at |
| | | | | | 40 km/h on |
| | | | | | George Street |
| Dec. 6, 2009 | 12:02:09 | Dec. 6, 2009 | 12:02:09 | 2346 | Bus stopped at |
| | | | | | intersection |
| | | | | | between Market |
| | | | | | Street and |
| | | | | | George Street |
| Dec. 6, 2009 | 12:10:09 | Dec. 6, 2009 | 12:10:09 | 2347 | Bus moving at |
| | | | | | 65 km/h, |
| | | | | | exceeded speed |
| | | | | | limit |
| Dec. 6, 2009 | 12:12:09 | Dec. 6, 2009 | 12:12:09 | 2348 | Bus emergency |
| Dec. 6, 2009 | 12:20:09 | Dec. 6, 2009 | 12:20:09 | 2349 | Driver event |

Additional fields in the index include the data streams, trigger rules associated with the event and additional comments by a user who is authorised to edit the index 128. Depending on the application and the search parameters, the index 128 can be used to resolve issues without having to retrieve the associated video footage. For example, the following fields can be reviewed for a particular complaint.

| Complaint | Fields in index (CSV file) |
|---|---|
| Food was spoiled | Docket, time, batch, |
| | temperature, camera |
| Garbage bin uncollected | Client address, GPS location, |
| | orientation, camera |
| Patient prescribed incorrect medicine | Patient name, bed number, |
| | medical history |
| Process stopped | Time, flow input, power input, load |

The index 128 can be accessed using the user interface subsystem 160 and downloadable to any computer-readable medium such as a USB hard drive or thumb drive.

Recordal 260

A checksum is then calculated by the processor 122 based on the data streams and the identifier of the video footage associated with the detected event; see step 250. The checksum and the linked description-identifier are then transmitted to the camera 102 to be stored with the video footage associated with the detected event.

Video footage is stored by the camera 102 in a format that prevents modification or tampering of the data. By storing the event description and checksum with the video footage, the same level of data integrity can be achieved to prove the source and accuracy of the data recorded.

By storing and/or transmitting data that is related to predetermined events and potential risks, the volume of data transmission and storage space can be reduced.

Handling Events Detected by Camera 102

In addition to events inferred from either directly from sensor 124 readings or from computations involving multiple or from a series of sensor 124 readings, an event can also be detected by the camera 102 itself. In this case, the processor 122 is also operable to process events detected by the camera 102.

The on-board processor 104 of the camera 102 receives data streams from the integrated or local sensors 108. If an event is detected based on the data streams, the camera 102 automatically captures video footage at a user-defined frame rate for a user-defined period of time.

The camera 102 then sends an alert in the form of a series of IP packets to the processor 122 to store the data streams, and add them to a database. The processor 122 generates a description of the event and calculates an identifier of the captured video footage based on the data streams received from the camera 102. The generated description and the identifier are then linked and stored in the database.

The camera 102 can be programmed to recognise a single word or character in a string sent to it and generate a specified event/record on the camera image on that basis, including a text message relevant to the sensor that triggered the event. For example the string ‘alarm’ could generate a text message ‘alarm-water level high’ on the camera image and then email that image. The ‘water level high’ message would be defined in relation to a specific water sensor that feeds into the processor 122.

User Interface Subsystem 160

In one form, the user interface is a personal computer 166 or mobile user equipment 168 having access to the camera 100, data administration 120 and distributed input/output 140 subsystems via the Internet 20.

In another form, the user interface is a dedicated terminal 164 with a high resolution monitor with touch screen functionality and integrated processing capability. The touch screen functionality allows the user to freely enter text to be embedded with a video footage. The user defined text can also be stored in the index to facilitate searching and retrieval of video footage.

The dedicated terminal 164 allows a user to access the camera subsystem 100, data administration subsystem 120 and distributed input/output subsystem 140 without the need for a personal computer 166. The dedicated terminal 164 also has WLAN connection capability, Bluetooth connectivity for VOIP headsets and Internet accessibility for sending emails.

A multitude of tasks can be performed by a user using the user interface subsystem 160, including:
configuration such as setting IP addressing, port selection and baud rates;
configuration of trigger rules referred by the processor 122 and device 142 to detect an event, responses and notifications;
searching video footage index and downloading index to a computer-readable medium;
reviewing captured or live JPEG images and video footage;
reviewing system help files, operator manuals and troubleshooting guides;
reviewing historical data in graphical format such as mean, average, trends, and accumulative data;
sourcing, compiling, converting and downloading identified video footage a storage that is either integral or from network attached storage (NAS);
alarm indication and acknowledgment;
audio monitoring and announcements to camera; and
operation of third party software programs such as OCR and Audio to Text.

The subsystem 140 incorporates 10 password protected user levels to provide for multiple users with different rights of access Review of video footage is only permissible for a user with access up to full system configuration and programming access. With multiple user levels of accessibility, interrogation can be structured for use dependent upon application. Users with a supervisory role can provide remote assistance to other users.

To ensure the information received by the camera 102 is the same as that generated by the data administration 120 and distributed input/output 140 subsystems, stringent password protected program is used to limit access to camera settings that determine the IP address of the component that information is from.

HTTP requests and acknowledge IP notifications that requires correct user name and password from the camera 102 to the subsystems 120, 140 are also used. By ‘handshaking’ the separate devices, the programmed source and destination for the information path is assured.

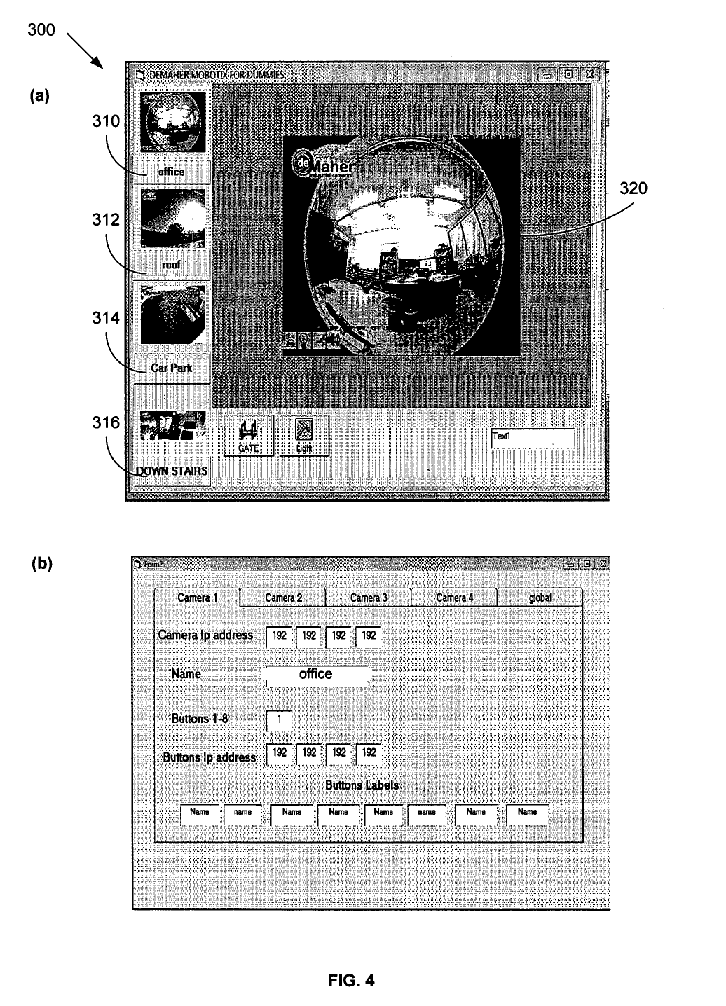

An exemplary user interface 300 for a system with four cameras 102 is shown in FIGS. 4(a) and 4(b). Specifically, the user interface 300 allows a user to select video footage of any one of the “office” 310, “reef” 312, “car park” 314 and “downstairs” 316 cameras for bigger display on the main screen 320. Configurations of each camera can be set up using the interface in FIG. 4(b), which allows a user to specify its IP address, name, and elements and sensors associated with it.

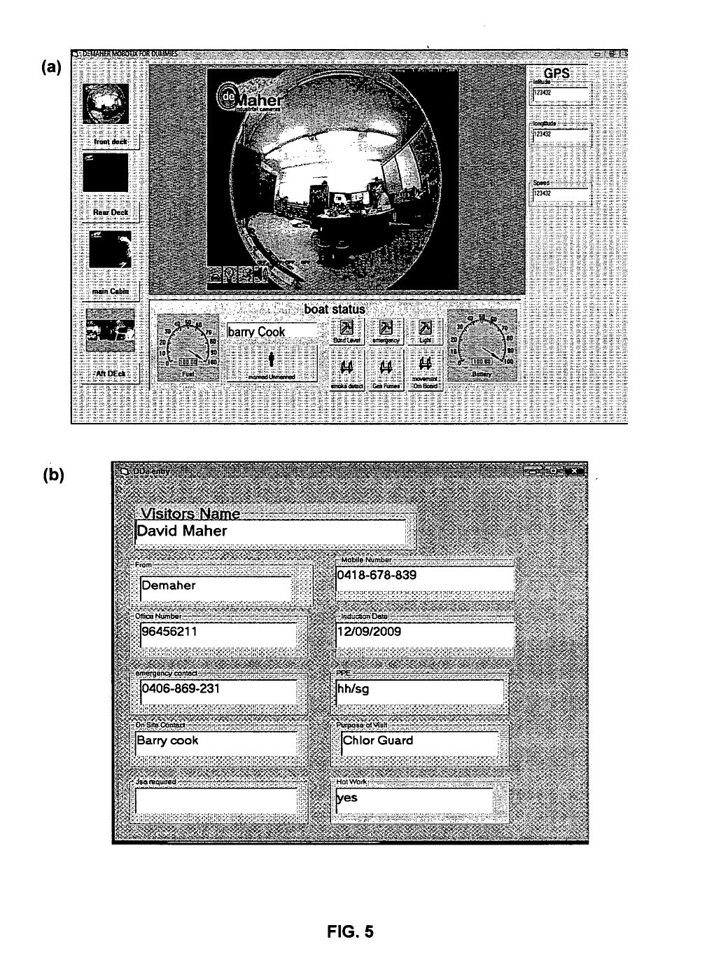

FIG. 5(a) shows another exemplary user interface of an application called “Harbour Master”, which is an alarm system designed for marine applications. In this application, sensors in the form of GPS sensor, smoke detector, water level detector and RFID swipe card is used to detect whether individuals or objects are permitted in the area. Data streams from the sensors are collected and analysed by the processor 122 to detect events. For example, the data streams can be used to check for excess movement when a boat is moored and to detect water level in bilges to ensure the safety of the boat. When an event is detected, the event will be stored and indexed for later retrieval and where applicable, an alarm will be activated.

Another exemplary application is to monitor a network of temperatures for health and food safety purposes. In this application, sensors 124 in the form of temperature sensors are distributed within a storage compound. Data streams collected by the temperature sensors are collected and analysed by the processor 122 to track temperatures for regulatory requirements and to detect whether temperatures stray beyond a predetermined limit.

FIG. 5(b) shows a further exemplary user interface for an application called “Gate Keeper”, which allows tracking of individuals and objects within a RFID zone. In this application, the individuals and objects will each carry a sensor 124 in the form of a RFID tag to send a data stream to the processor 122. The data streams collected are analysed to whether objects such as laptops are permitted to enter the zone. This is performed by referring to a database that defines access and rules for entry or exit. If an event is detected, a response will be generated, such as alerting the person responsible or activating an alarm.

In another example, data streams from RFID tags on clothing items such as helmet and boots are checked to determine whether the individual satisfies the safety requirement. Each entry or exit of an individual or object is recorded as an “event” and indexed with the video footage associated with the event for future search and retrieval. For example, a user can search for individuals failing to satisfy the safety requirement on a particular day, and retrieve the footage associated with the events.

Distributed Input/Output Subsystem 140

Distributed input/output subsystem 140 comprises a ‘stand alone’ device 142 that is network deployed, POE powered and connected to a number of digital input/output elements 144 (8in/8out) on a single board. For example, lights, pumps, electronic locks and power control system can be connected to the device 142. The system allows control of up to eight elements 144 associated with a camera 102.

Similar to the external sensors 124 in the data administration subsystem 120, the devices 142 increases the amount of field connected equipment that can be connected directly into the camera subsystem 100 whilst maintaining network based communication. Through TCP/IP notifications, the elements 144 can trigger events iii the camera subsystem 100 to obtain an event identifier.

Response 270

Based on predetermined events, the distributed input/output subsystem 140 is capable of defining actions and escalation paths. A programmable management layer controls how actions and escalation paths are set up and operate.

In particular, the device 142 is used to control the digital input/output elements 144 in response to an event detected by the data administration subsystem 120. Referring to step 270 in FIG. 3, processor 122 generates and sends a control signal to the device 142. For example, light switching and power control can be performed when an event is detected. The control signal can also be used to send a notification to the relevant authority or to activate an alarm.

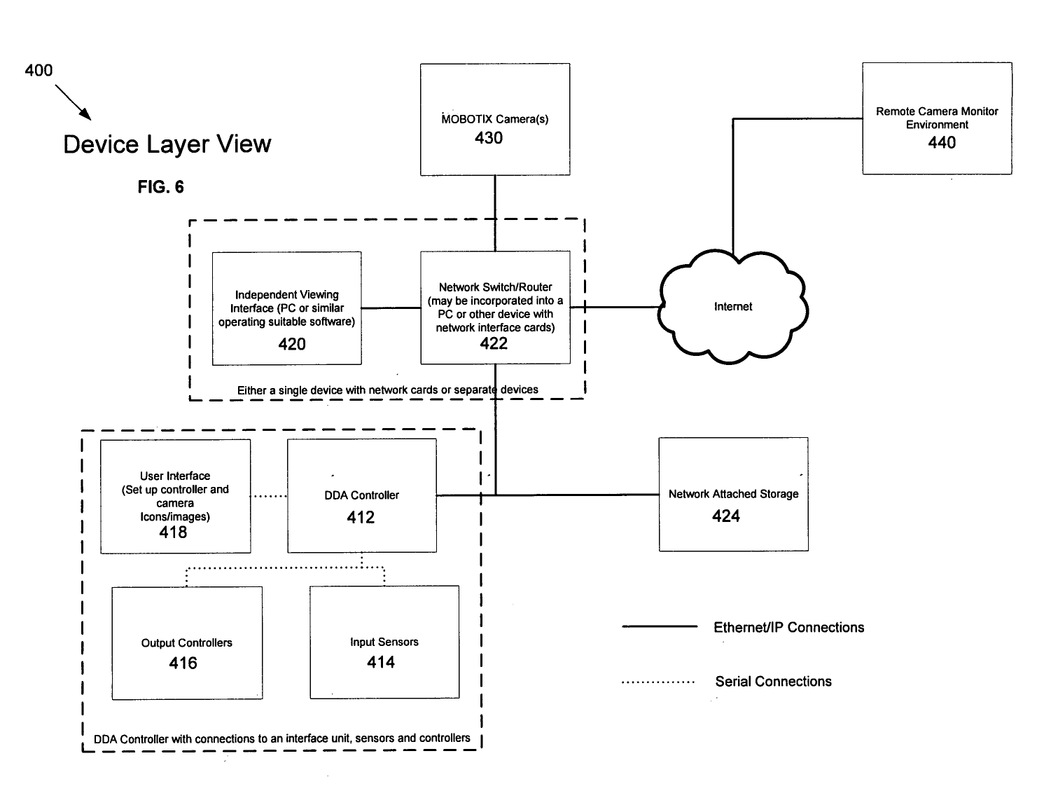

Referring now to FIGS. 6 to 8, the system can be implemented using an exemplary three-tier software architecture comprising a device layer, a programmable management layer and an application level layer.

As shown in FIG. 6, the device layer defines the communication paths among the different subsystems in the system. The data administration subsystem (DDA controller 412) is in serial communication with a plurality of input sensors 414, output controllers 416 and a local user interface that allows users to configure the DDA controller.

Also in communication with the DDA controller 412 is one or more Mobotix Cameras 430 operable to capture video footage when an event is detected, either by the camera itself or by the DDA controller 412 based on data streams collected from the input sensors 414. Viewing and searching of video footage can be performed locally using a PC 420, or remotely 440 via the Internet. The system also has a network attached storage 424.

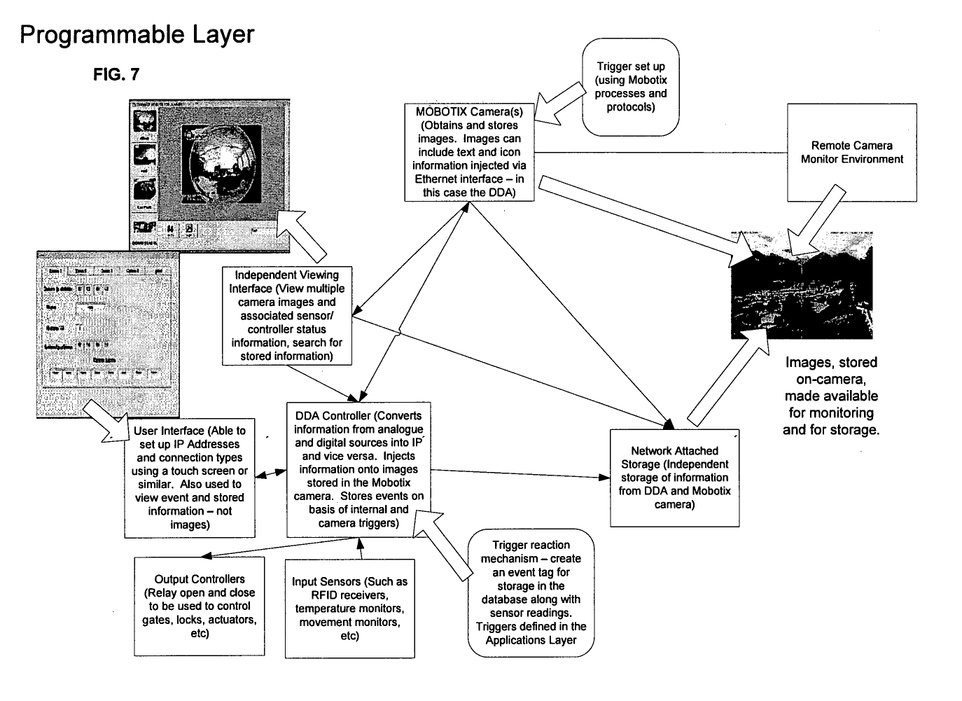

Referring now to FIG. 7, the programmable layer allows user configuration of various system settings. The DDA controller 412 can read and interpret both variable and on/off measures. The user can define one or more tests for each sensor by entering the unique sensor ID, the test (switch is on or off, sensed data is greater than, less than or equal to specific number/measure etc) and the activity or activities that will occur if that test is met. Depending on the purpose of the sensor, examples include analogue inputs with set or trip points (e.g. overweight, over-speed, over temperature, excessive moisture) and digital inputs (e.g. panic button, stop button, nurse call).

The triggered activities can include sending text to the camera, sending email alerts to other sources, sending data strings to a central location, sending SMS, sending data to a central system or control room etc. An example of multiple tests for one sensor would be a warning if water rises above a specified level and an emergency alert or escalation when it rises to a higher level than that. It is also possible to program multiple and/or conditions, although this would at present need to be a customised usage.

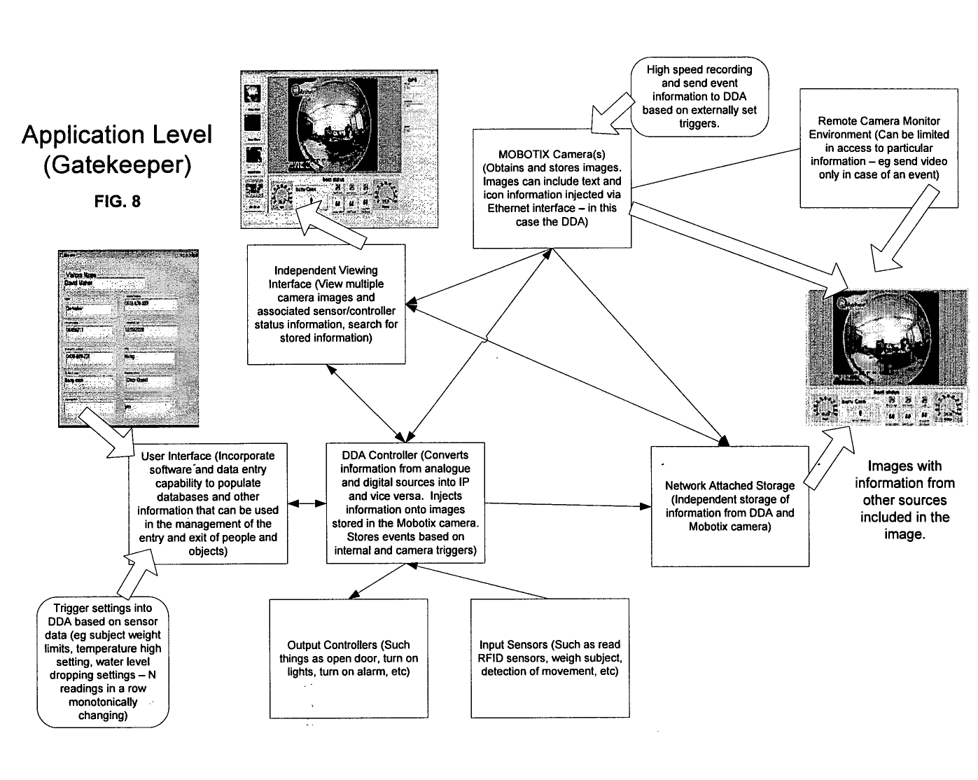

Finally, the application layer shown in FIG. 8 allows a specific application such as the “Gate Keeper” described with reference to FIG. 5(b) to be built. In this case, trigger settings based on data streams collected by sensors such as RFID sensors and motion detector can be configured.

Time Synchronisation 280

It is important that a consistent source is referred by the subsystems for time synchronisation; see step 280 in FIG. 3. As the system 10 is IP based, the primary time reference is an internal camera clock on the camera 102 in the camera subsystem 100, which can be updated regularly from using Network Time Protocol.

Other time references can be gained from sensors 124 within the system 10 depending on their inclusion, such as Universal Time Clock (UTC) provided by a GPS input data stream and, as a backup, the internal Real time clock (RTC) within the user interface subsystem 160. Network latency, power failure and transmission path latency are potential issues where discrepancies in time references may arise.

To identify any discrepancies in the time signals received, the data administration subsystem 120 is operable to initiate a ‘Time Slice Polling’ of all devices within the system 10. Specifically, processor 122 is operable to receive time references from the camera 102, the sensors 124 and the distributed input/output subsystem 160 and to trigger a time synchronisation event if the time references are not synchronised. The time synchronisation event in a CSV file detailing the individual times and relevant error rates and the subsystems are then reset according to the camera's clock.

The system time clock can be reset periodically, such as every 24 hours, to either Network Time Protocol or the camera's master clock. This will happen at the same time as a reboot of all devices, intended to prevent buffer overflows and other external influences affecting sensor performance and operation. This reboot is factory set for a certain time but can be modified by an operator.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive. For example, the distributed input/output subsystem 140 can provide connectivity with alternative technologies such as CBUS modules.

The data administration subsystem 120 may further comprise an Internet crawler component that automatically crawls the Internet for additional information relating to an event or video footage for storage in the searchable index. For example, news articles related to crime in an area, or links to the articles, can be automatically compiled and stored with relevant video footage of that area to facilitate searching.

It should also be understood that, unless specifically stated otherwise as apparent from the following discussion, it is appreciated that throughout the description, discussions utilizing terms such as “receiving”, “processing”, “retrieving”, “selecting”, “calculating”, “determining”, “displaying”, “generating”, “linking” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices. Unless the context clearly requires otherwise, words using singular or plural number also include the plural or singular number respectively.

It should also be understood that the techniques described might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media (e.g. copper wire, coaxial cable, fibre optic media). Exemplary carrier waves may take the form of electrical, electromagnetic or optical signals conveying digital data steams along a local network or a publically accessible network such as the Internet.

1. A computer system for detecting events, the system comprising:
a processor, a plurality of sensors and a camera, the processor in communication with the sensors and the camera over a communications network;
the processor is operable to receive multiple data streams from the sensors, to analyse the received data streams to detect an event, to send a trigger to the camera to capture video footage when an event is detected by the processor;
the camera is operable to capture video footage when a trigger is received from the processor, and to capture video footage and send an alert to the processor when an event is detected by the camera, and
when an event is detected by the processor or an alert is received from the camera, the processor is operable to:
generate an event description associated with the detected event based on the data streams or the alert from the camera,
link the generated description with an identifier of the captured video footage associated with the event, and store the linked description and identifier to facilitate searching and retrieval of the captured video footage associated with the detected event.

2. A computer system of claim 1, wherein the processor is further operable to send the linked event description and identifier to the camera for recordal with the captured video footage associated with the detected event.

3. A computer system of claim 2, wherein the camera is further operable to:
receive the linked event description and identifier; and
record the received linked event description and identifier are recorded with the video footage in an encoded and encrypted format.

4. A computer system of claim 3, wherein the format is MxPeg format.

5. A computer system of claim 1, wherein the processor is further operable to calculate a checksum associated with the detected event and to send the calculated checksum to the camera for recordal with the captured video footage associated with the detected event.

6. A computer system of claim 5, wherein the checksum is calculated based on the data streams and the identifier of the captured video footage associated with the detected event.

7. A computer system of claim 1, wherein the processor is further operable to send user-defined text to the camera for recordal with the captured video footage associated with the detected event.

8. A computer system of claim 1, wherein the processor is further operable to store the linked description and identifier in a searchable index.,

9. A computer system of claim 1, wherein the processor is further operable to send a control signal to a device to perform a task based on the detected event.

10. A computer system of claim 1, wherein the processor is further operable to receive time references from the camera and from the sensors, and to trigger a time synchronisation event if the received time references are not synchronised

11. A computer system of claim 1, wherein an event is detected by the processor based on at least one of the data streams satisfying a trigger rule associated with an event.

12. A computer system of claim 11, wherein searching and retrieval of the video footage is based on the one or more trigger rules.

13. A computer system of claim 1, wherein searching and retrieval of the video footage is based on one or more of the following search parameters:
date and time;
event description;
trigger rules of an event; and
identifier of video footage.

14. A computer system of claim 1, wherein retrieval of the captured video footage is only permissible if a user is authorised to access the video footage.

15. A computer system of claim 1, wherein the processor is operable to receive data streams from the sensors by means of one of the following: digital communication, serial communication, analogue voltage reference, fieldbus communication and TCP/IP.

16. A computer system of claim 1, wherein the processor is further operable to collate the data streams received from the sensors into a unified format.

17. A computer program to implement the computer system according to claim 1.

18. A computer-implemented method for detecting events, the method comprising:
receiving multiple data streams from a plurality of sensors and analysing the received data streams to detect an event, and triggering the camera to capture video footage associated with the detected event;
when an event is detected by the processor or an alert is received from the camera,
generating an event description of the detected event based on the data streams or the alert; linking the generated event description and an identifier of the captured video
footage, and storing the linked event description and identifier to facilitate searching and retrieval of the captured video footage associated with the detected event.
